(19) United States
(12) Patent Application Publication
(10) Pub. No.: US 2025/0202153 A1
(43) Pub. Date: Jun. 19, 2025

(54) Electric shock prevention baffle structure of a pin assembly

(71) Applicant: Feng Wang, Dongguan (CN)

(72) Inventor: Feng Wang, Dongguan (CN)

(21) Appl. No.: 18/792,913

(22) Filed: Aug. 2, 2024

(30) Foreign Application Priority Data
Dec. 13, 2023 (CN) 202323409738.7

(51) Int. Cl. H01R 13/453; H01R 13/652

(52) U.S. Cl. CPC H01R 13/4534; H01R 13/652

(57) ABSTRACT

The utility model discloses an electric shock prevention baffle structure of a pin assembly, a sliding groove is formed on the side walls of the main body upper cover and the main body lower cover, movable baffle grooves are respectively formed on the inward two sides of the sliding groove, a key movable groove is formed in the middle of the movable electric shock prevention baffle, and an installation yielding groove is formed on one side of the key movable groove. The utility model aims to provide a baffle structure for improving the electric shock prevention of pins.

### CROSS REFERENCE TO RELATED APPLICATION

This application claims priority benefit of Chinese patent Application No. 202323409738. 7, filed on Dec. 13, 2023, and the entire contents of which are incorporated herein by reference.

### TECHNICAL FIELD

The utility model relates to the field of power converters, in particular to an electric shock prevention baffle structure of a pin assembly.

### BACKGROUND ART

Because the specifications of plugs and sockets in different countries are different, they can't be used universally. If you need to insert the plugs into sockets with mismatched specifications, you need to go through a power converter. The power converter is a switching tool. When in use, the power converter is inserted into the target socket, and then the target plug is inserted into the matching socket hole on the power converter to realize the conversion. The appearance of power converter improves the convenience of people's life outside, especially when they travel internationally, so there is no need to worry about the trouble caused by the mismatch between the plug of the electronic equipment they carry and the local power socket.

In the traditional power converter, the pins are generally fixed and extended. For the power converter with multiple pins, it is necessary to set multiple pins. If one pin is pushed out, the gap of the sliding groove can contact the internal metal parts with objects from the outside, which will lead to the risk of electric shock.

### SUMMARY OF THE UTILITY MODEL

In view of the above shortcomings, the purpose of the utility model is to provide an electric shock prevention baffle structure of the pin assembly, which can completely block the gap of the sliding groove after any pin is pushed out, thus preventing the risk of electric shock.

The technical scheme adopted by the utility model is as follows:

An electric shock prevention baffle structure of pin assembly comprises a main body upper cover and a main body lower cover installed on the main body upper cover, wherein the main body upper cover is provided with socket holes, the main body lower cover comprises a bottom plate and a side plate vertically connected to the bottom plate, the bottom plate is provided with a combined jack group, and at least one pin assembly arranged on the main body lower cover, and each pin assembly comprises at least one live pin, at least one zero pin and a key; A convex bar extending along the length direction of the guide post is formed on the guide post, one end of the convex bar connected with the bottom plate is provided with a notch, the key piece comprises a key, a fixed electric shock prevention baffle is formed inside the key, and a movable electric shock prevention baffle is arranged between the fixed electric shock prevention baffle and the key; The side walls of the main body upper cover and the main body lower cover are provided with sliding grooves for the keys to slide, and the inner sides of the sliding grooves are respectively provided with a movable baffle groove for the movable electric shock prevention baffle to embed and slide; the middle part of the movable electric shock prevention baffle is provided with a movable key groove for the keys to move, and one side of the movable key groove is provided with an installation yielding groove for the keys to pass through and install.

As a further improvement of the utility model, the key movable groove is a rectangular or arc-shaped runway shape as a whole.

As a further improvement of the utility model, the pin assembly includes American standard pin assembly, British standard pin assembly, and Chinese or Australian standard pin assembly.

As a further improvement of the utility model, the American standard pin assembly comprises a first connector, a first key piece connected to the first connector, a first positioning post vertically arranged inside the lower cover of the main body and sequentially penetrating the first connector, and a first guide post perpendicular to the main body lower cover and penetrating the first connector; A first convex bar is formed on the first guide post along the length direction of the first guide post, and one end of the first convex bar corresponding to the bottom plate is provided with a first notch.

As a further improvement of the utility model, the first connector comprises a first connection main body and a first pin vertically connected to the first connection main body and matched with the combined jack group, and the upper end surface of the first connection main body is formed with a first buckle respectively engaged with two sides of one end of the first key piece near the side plate, a second buckle engaged with one end of the first key piece far from the side plate, a first plug-in positioning hole for the first positioning post to pass through, and a first plug-in positioning hole for the first positioning post to pass through. The first key piece comprises a first key main body and a first key connected to one end of the first key main body and sliding between the upper cover and the main body lower cover; the first key main body comprises a first key engaging portion connected to one end of the first key and a first movable engaging portion connected to the other end of the first key engaging portion; a first pressing block movable in the first accommodating groove is formed on the lower end face of the first key engaging portion; A first key positioning hole is formed in the middle of the joint between the first key engaging portion and the first movable engaging portion, and the first movable engaging portion is provided with a first key movable groove facing the first convex hole, and the first key positioning hole and the first key positioning hole are overlapped and sleeved on the first positioning post, and the first convex hole and the first key movable groove are overlapped and sleeved on the first guide post; The first spring is accommodated in the first accommodating groove with one end abutting against the innermost side of the first accommodating groove and the other end abutting against the first abutting block; A first fixed electric shock prevention baffle is arranged on the inner side of the first key, and a first movable electric shock prevention baffle is also arranged between the first fixed electric shock prevention baffle and the first key; The side walls of the main body upper cover and the main body lower cover are provided with a first sliding groove for the first key to slide, and the inward two sides of the first sliding groove are respectively provided with a first movable baffle groove for the first movable electric shock prevention baffle to embed and slide, and the inner side of the first movable baffle groove is provided with a first fixed baffle groove for the first fixed electric shock prevention baffle to slide; The middle part of the first movable electric shock prevention baffle is provided with a first key movable groove for the first key to move, and one side of the first key movable groove is provided with a first installation yielding groove for the first key to pass through and install.

As a further improvement of the utility model, the British standard pin assembly comprises a second connector, a second key connected to the second connector in a sliding way, a second positioning post vertically arranged on the inside of the lower cover of the main body and sequentially penetrating the second connector, and a second guide post perpendicular to the lower cover of the main body and penetrating the second connector; A second convex bar is formed on the second guide post along the length direction of the second guide post, and a second notch is formed at one end of the second convex bar corresponding to the bottom plate.

As a further improvement of the utility model, the second connector comprises a second connection main body and a second pin vertically connected to the second connection main body and matched with the combined jack group, and the upper end surface of the second connection main body is formed with a fourth buckle respectively engaged with two sides of one end of the second key piece near the side plate, a fourth buckle engaged with one end of the second key piece far from the side plate, a second connection positioning hole for the second positioning post to pass through, and a second plug-in positioning hole for the second positioning post to pass through. The second key piece comprises a second key body and a second key connected to one end of the second key body and sliding between the upper cover and the lower cover of the main body, wherein the second key body comprises a second key engaging portion connected to one end of the second key and a second movable engaging portion connected to the other end of the second key engaging portion, and a second pressing block movable in the second accommodating groove is formed on the lower end surface of the second key engaging portion. The second movable engaging portion is provided with a second key movable groove opposite to the second convex hole, the second plug-in positioning hole is sleeved on the second positioning post, and the second convex hole and the second key movable groove are overlapped and sleeved on the second guide post; The second spring is accommodated in that second accommodate groove, one end of the second spring abuts against the innermost side of the second accommodating groove, and the other end of the second spring abuts against the second abutting block; A second fixed electric shock prevention baffle is arranged on the inner side of the second key, and a second movable electric shock prevention baffle is also arranged between the second fixed electric shock prevention baffle and the second key; The side walls of the main body upper cover and the main body lower cover are formed with a second sliding groove for the second key to slide, and the inward two sides of the second sliding groove are respectively formed with a second movable baffle groove for the second movable electric shock prevention baffle to embed and slide, and the inner side of the second movable baffle groove is provided with a second fixed baffle groove for the second fixed electric shock prevention baffle to slide; The middle part of the second movable electric shock prevention baffle is provided with a second key movable groove for the second key to move, and one side of the second key movable groove is provided with a second installation yielding groove for the second key to pass through and install.

As a further improvement of the utility model, the Chinese standard or Australian standard pin assembly comprises a fourth connector, a fourth key piece connected to the fourth connector, a fourth positioning post vertically arranged inside the lower cover of the main body and passing through the fourth connector in turn, and at least one fourth guide post perpendicular to the lower cover of the main body and passing through the fourth connector; A fourth convex bar is formed on the fourth guide post along the length direction of the fourth guide post, and a fourth notch is formed at one end of the fourth convex bar corresponding to the bottom plate.

As a further improvement of the utility model, the fourth connector comprises a fourth connector main body and a fourth pin vertically connected to the fourth connector main body and matched with the combined jack group, and the upper end surface of the fourth connector main body is formed with at least one sixth buckle clamped on the side of the fourth key piece, a fourth connector positioning hole for the fourth positioning post to pass through, at least one fourth convex hole for the fourth guide post to pass through and move, and the fourth convex hole for the fourth guide post to pass through. The fourth key piece comprises a fourth key body and a fourth key connected to one end of the fourth key body and sliding between the upper cover and the lower cover of the main body, and a fourth pressing block moving in the fourth accommodating groove is formed on the lower end face of one end of the fourth key body close to the fourth key. The fourth key is provided with a fourth key positioning hole facing the fourth plug-in positioning hole and a fourth key movable groove facing the fourth convex hole, and the fourth plug-in positioning hole and the fourth key positioning hole are overlapped and sleeved on the fourth positioning post, and the fourth convex hole and the fourth key movable groove are overlapped and sleeved on the fourth guide post; The fourth spring is accommodated in the fourth accommodating groove, one end of which abuts against the innermost side of the fourth accommodating groove and the other end of which abuts against the fourth abutting block; A fourth fixed electric shock prevention baffle is arranged on the inner side of the fourth key, and a fourth movable electric shock prevention baffle is also arranged between the fourth fixed electric shock prevention baffle and the fourth key; A fourth sliding groove for the fourth key to slide is formed on the side walls of the upper cover and the lower cover of the main body, and a fourth movable baffle groove for the fourth movable electric shock prevention baffle to embed and slide is respectively formed on the inward two sides of the fourth sliding groove, and a fourth fixed baffle groove for the fourth fixed electric shock prevention baffle to slide is opened at the inner side of the fourth movable baffle groove; The middle part of the fourth movable electric shock prevention baffle is provided with a fourth key movable groove for the fourth key to move, and one side of the fourth key movable groove is provided with a fourth installation yielding groove for the fourth key to pass through and install.

The utility model has the beneficial effects that:

The American standard pin assembly is suitable for American standard plug sockets, the British standard pin assembly is suitable for British standard plug sockets, and the combined plug-in panel can be correspondingly assembled between the upper cover and the lower cover of the main body, so as to expand the use of the power converter with the pin-specified structure to replace different jacks and pins, expand the use range of the power converter and improve the practicability of the power converter. The Chinese standard or Australian standard pin assembly can be used for Chinese plug sockets or Australian plug sockets. Through the mutual cooperation and conversion between the pin components, users can replace different pins correspondingly, without worrying about the trouble caused by the mismatch between the plug of the electronic equipment they carry and the local power socket. In addition, external force can be applied between the American standard pin assembly, the British standard pin assembly, the combined plug-in panel, the Chinese standard pin assembly or the Australian standard pin assembly, so that the sliding conversion between different pins can be realized, and the groove of the sliding groove is completely blocked after any pin is pushed out, thereby preventing the risk of electric shock.

The above is an overview of the technical scheme of the utility model, and the following is a further explanation of the utility model with the attached drawings and specific embodiments.

### BRIEF DESCRIPTION OF THE DRAWINGS

FIG. 1 is a back schematic diagram of the utility model;

FIG. 2 is the front schematic diagram of the utility model;

FIG. 3 is the internal structure diagram of the utility model;

FIG. 4 is the explosion diagram of American standard pin assembly;

FIG. 5 is the explosion diagram of the British standard pin assembly;

FIG. 6 is the explosion diagram of the Chinese standard pin assembly;

FIG. 7 is the front view of the main body lower cover;

FIG. 8 is a perspective view of the main body lower cover;

FIG. 9 is the schematic diagram of the Chinese standard pin assembly in the initial position;

FIG. 10 is the schematic diagram of the Chinese standard pin assembly during moving;

FIG. 11 is the schematic diagram of the Chinese standard pin assembly in the termination position;

FIG. 12 is a schematic side view of the utility model;

FIG. 13 is another side schematic diagram of the utility model;

FIG. 14 is a schematic diagram of the internal structure of the main body upper cover;

FIG. 15 is the schematic diagram of the internal structure of the main body lower cover;

FIG. 16 is the structural schematic diagram of the movable electric shock prevention baffle;

FIG. 17 is the structural schematic diagram of the guide post;

FIG. 18 is the schematic diagram between the movable electric shock prevention baffle and the key and the fixed electric shock prevention baffle;

FIG. 19 is another schematic diagram between the movable electric shock prevention baffle and the key and the fixed electric shock prevention baffle;

In the figure: 10. Pin fixing structure;
20, the main body cover; 21. Socket hole;
30. Main body lower cover; 31. Bottom plate; 32. Side plates; 33. Combined jack group;
40. American standard pin assembly; 41. First connector; 411. A first connector main body; 4111. A first buckle; 4112, A second buckle; 4113. A first plug-in positioning hole; 4114. A first convex hole; 4115. A first accommodating groove; 412. A first pin; 42. A first key; 421. A first key main body; 4211. A first key engaging portion; 42111, A first pressing block; 4212. A first movable engaging portion; 42121, the first key movable groove; 422. A first key; 44. A first positioning post; 45, the first guide post; 451. A first convex bar; 452, A first notch; 46. A first fixed electric shock prevention baffle; 47. A first movable electric shock prevention baffle; 471. A first key movable groove; 472, A first installation yield groove;
50. British standard pin assembly; 51. Second connector; 511. A second connector main body; 5111, A fourth buckle; 5112, A fourth buckle; 5113. A second plug-in positioning hole; 5114, A second convex hole; 5115. A second accommodating groove; 512. A second pin; 52. A Second key; 521. A second key body; 5211. A second key engaging portion; 52111, A second pressing block; 5212. A second movable engaging portion; 52121. A second key movable groove; 5213. A second key positioning hole; 522. A second key; 54. A second positioning post; 55, A second guide post; 551. A second convex bar; 552, A second notch; 56. A second fixed electric shock prevention baffle; 57. A second movable electric shock prevention baffle; 571. A second key active groove; 572, the second installation yield groove;
80. Chinese standard or Australian standard pin assembly; 81. A fourth connector; 811. A fourth connector main body; 8111, A sixth buckle; 8112. A fourth plug-in positioning hole; 8113, A fourth convex hole; 8114, A fourth accommodating groove; 812, A fourth pin; 82. A fourth key; 821. A fourth key body; 8211, A fourth pressing block; 8212. A fourth key positioning hole; 8213. A fourth key active groove; 822. A fourth key; 84. A fourth positioning post; 85, A fourth guide post; 851, A fourth convex bar; 852, A fourth notch; 86, A fourth fixed electric shock prevention baffle; 87. A fourth movable electric shock prevention baffle; 871. A fourth key movable groove; 872, A fourth installation yield groove;
901. A first sliding groove; 902. A first movable baffle groove; 903. A first fixed baffle groove; 904. A second sliding groove; 905. A second movable baffle groove; 906. A second fixed baffle groove; 910, A fourth sliding groove; 911. A fourth movable baffle groove; 912, A fourth fixed baffle groove.

### DETAILED DESCRIPTION

In order to further explain the technical means and effects adopted by the utility model to achieve the predetermined purpose, the specific implementation of the utility model will be described in detail with the drawings and preferred embodiments.

In the description of the utility model, it should be understood that the terms “length”, “width”, “on”, “under”, “front”, “back”, “left”, “right”, “vertical”, “horizontal”, “top”, “bottom”, “inside” and “outside”.

In addition, the terms “first” and “second” are only used for descriptive purposes, and cannot be understood as indicating or implying relative importance or implicitly indicating the number of indicated technical features. Therefore, the features defined as “first” and “second” may include one or more of these features explicitly or implicitly. In the description of the utility model, the meaning of “multiple” is two or more, unless otherwise specified.

In this utility model, unless otherwise specified and limited, the terms “installation”, “connection”, “link” and “fixation” should be broadly understood, for example, they can be fixed connection, detachable connection or integrated; It can be a mechanical connection or an electrical connection; Can be directly connected, can also be indirectly connected through an intermediary, can be the internal connection of two elements or the interaction between two elements. For ordinary technicians in this field, the specific meanings of the above terms in this utility model can be understood according to the specific situation.

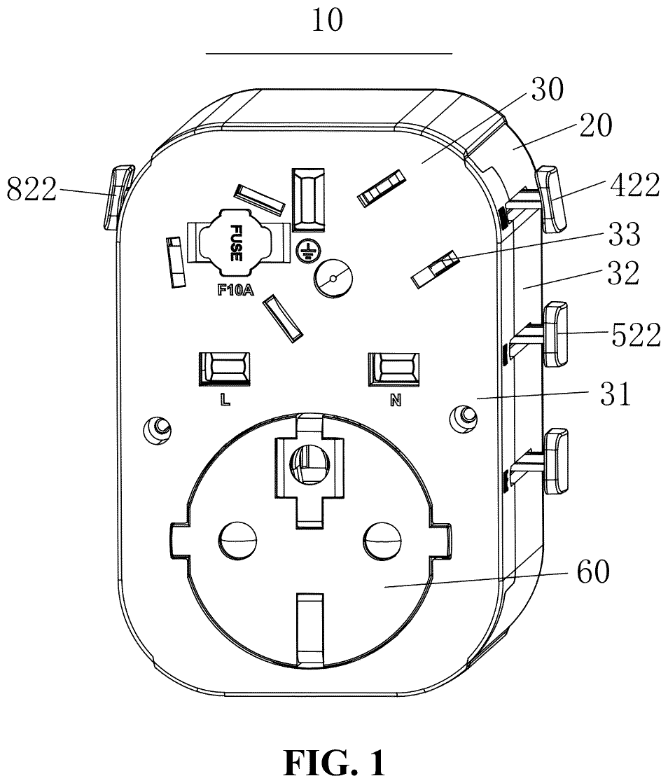

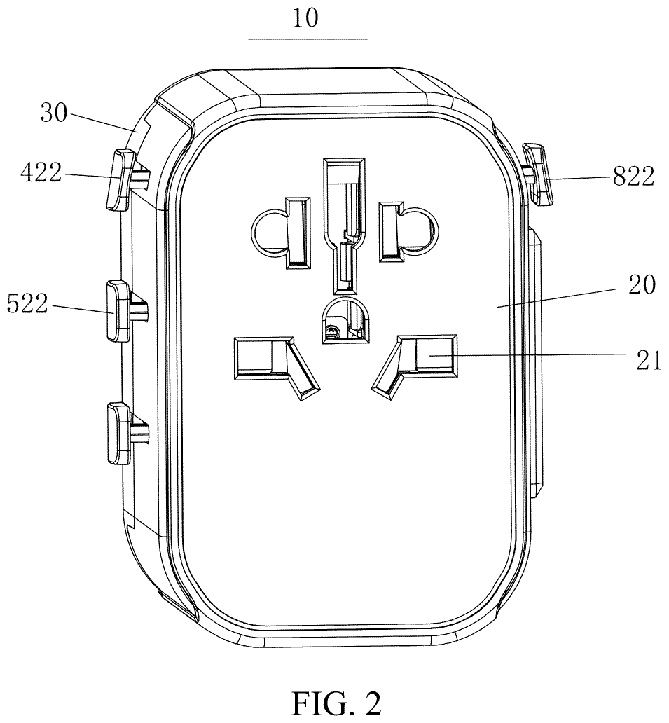

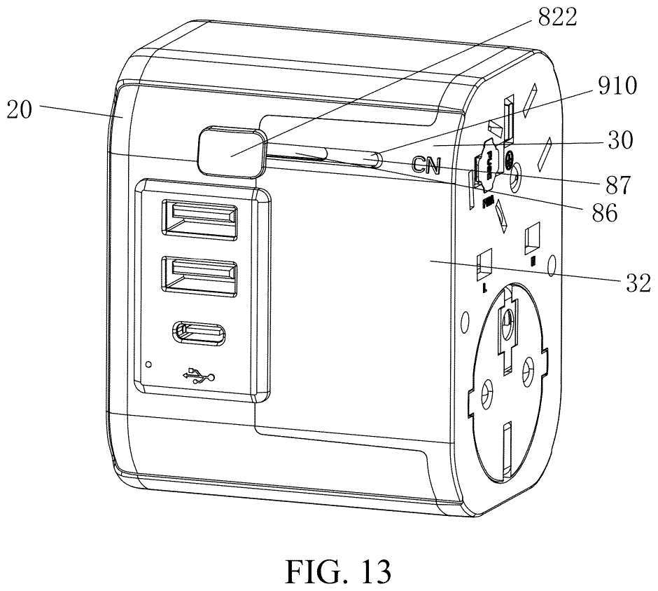

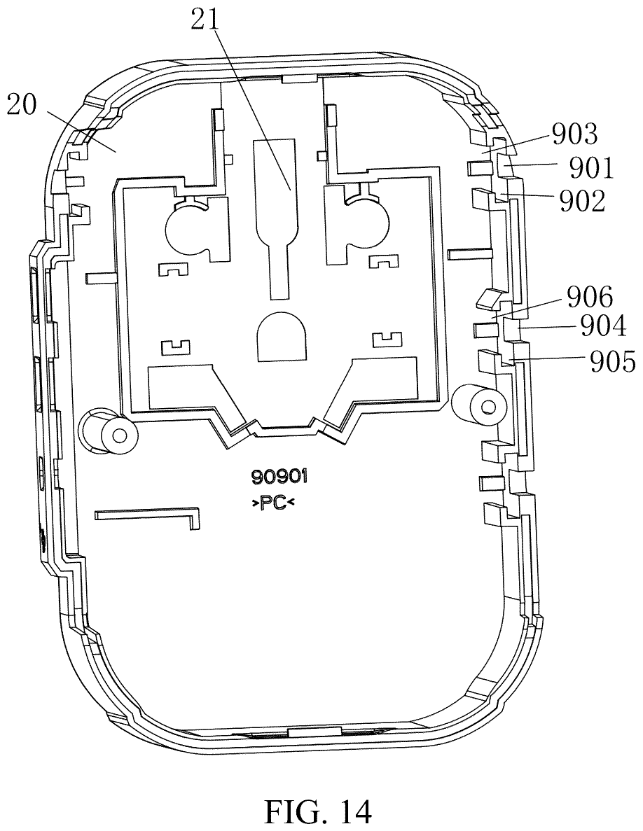

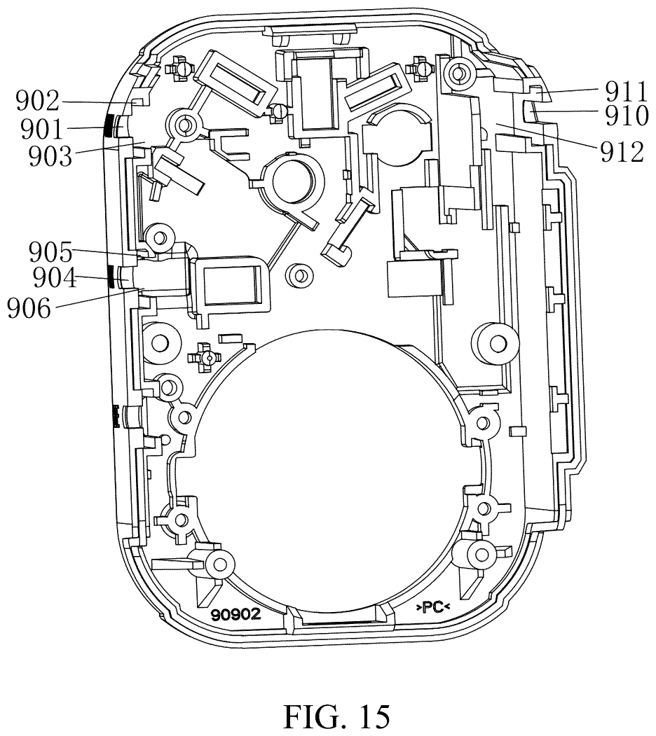

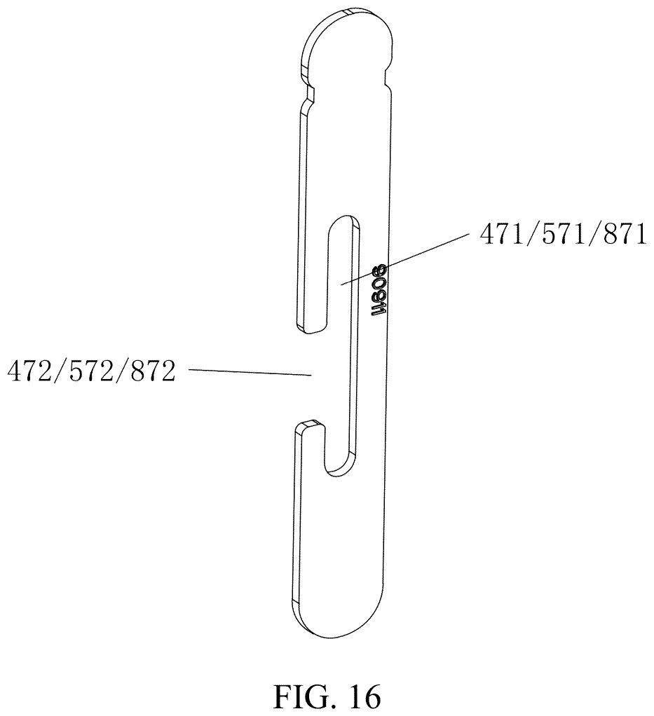

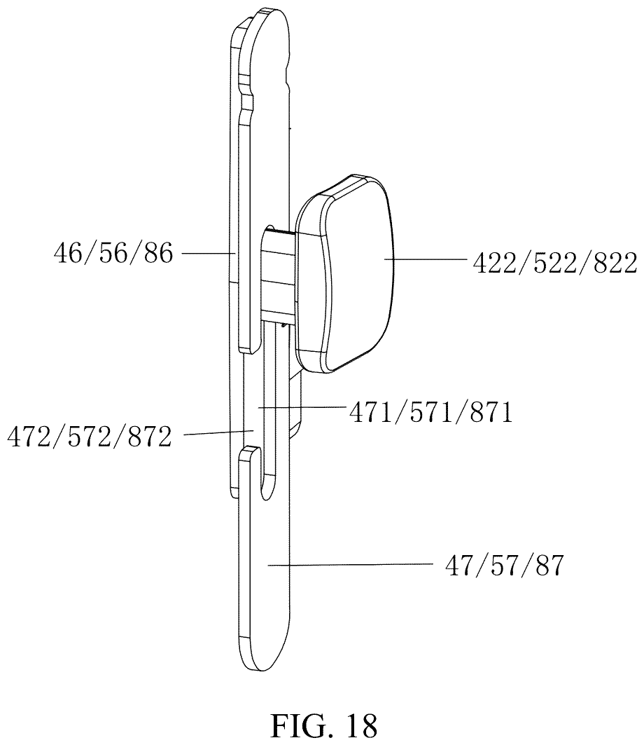

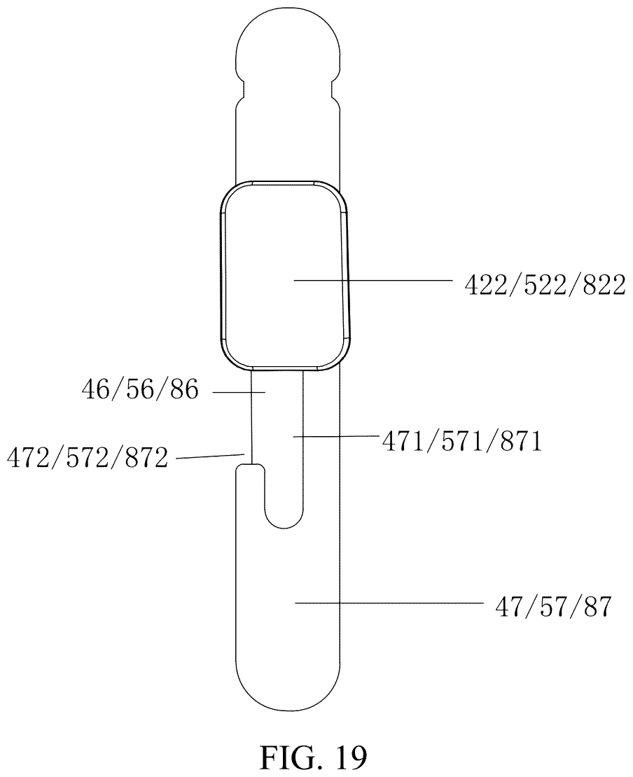

Please refer to FIG. 1 to FIG. 19, the embodiment of the utility model provides an electric shock prevention baffle structure of a pin assembly, which comprises a main body upper cover 20 and a main body lower cover 30 installed on the main body upper cover 20, wherein the main body upper cover 20 is provided with a socket hole 21, and the main body lower cover 30 comprises a bottom plate 31 and a side plate 32 vertically connected to the bottom plate 31, and the bottom plate 32 is provided with a combined jack group 33. Further comprises at least one pin assembly (40, 50, 80) arranged on the lower cover 30 of the main body, wherein each pin assembly (40, 50, 80) comprises at least one live pin, at least one zero pin and a key (422, 522, 822); the guide posts (45, 55, 85) are formed with convex bars (451, 551, 851) extending along the length direction of the guide posts (45, 55, 85), and one end of the convex bars (451, 551, 851) connected with the bottom plate 31 is provided with a notch (452, 552, 851). A fixed electric shock prevention baffle (46, 56, 86) is formed inside the keys (422, 522, 822), and a movable electric shock prevention baffle (47, 57, 87) is arranged between the fixed electric shock prevention baffle (46, 56, 86) and the keys (422, 522, 822). A sliding groove (901, 904, 910) for the keys (422, 522, 822) to slide are formed on the side walls of the main body upper cover 20 and the main body lower cover 30, and the inner side of the sliding groove (901, 904, 910) is respectively formed with a movable baffle groove (902, 905, 911) for the movable electric shock prevention baffle (47, 57, 87) to embed and slide. A fixed baffle groove (903, 906, 912) is provided on the inner side of the movable baffle groove (902, 905, 911) for sliding the fixed electric shock prevention baffle (46, 56, 86). The middle part of the movable electric shock prevention baffle (47, 57, 87) is provided with a key movable groove (471, 571, 871) for the keys (422, 522, 822), and one side of the key movable groove (471, 571, 871) is provided with a an installation yielding groove (472, 572, 872) for the keys (422, 522, 822) to pass through and install.

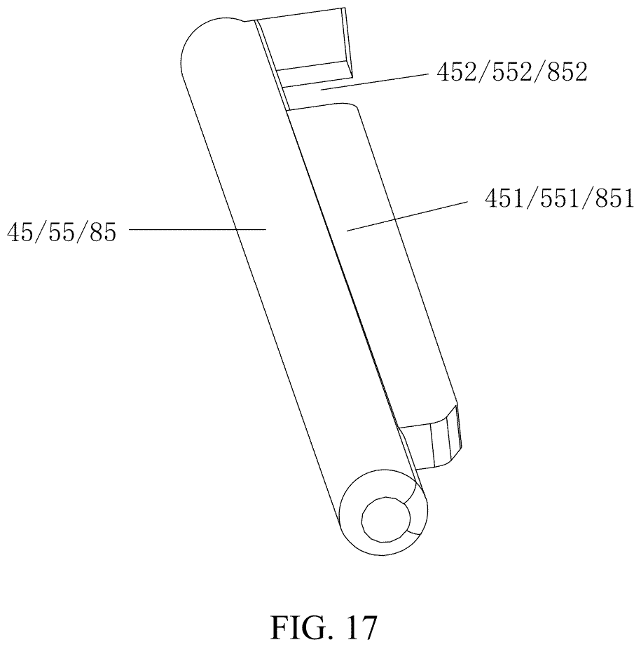

As for the specific shape arrangement of the key movable grooves (471, 571, 871), as shown in FIGS. 17 to 20, the key movable grooves (471, 571, 871) are in a rectangular or arc arc-shaped runway shape as a whole, so that the keys (422, 522, 822) can be conveniently arranged in the key movable grooves (471, 571, 822). And the movable electric shock prevention baffle (47, 57, 87) can more easily resist between the keys (422, 522, 822) and the sliding grooves (901, 904, 910) and fill the gap between the sliding grooves (901, 904, 910) and the keys (422, 522, 822). In this embodiment, the key movable grooves (471, 571, 871) are in the shape of arc-shaped runway, and their shapes are matched with the sliding grooves (901, 904, 910).

For the specific arrangement of the pin assembly, the pin assembly includes American standard pin assembly 40, British standard pin assembly 50, and Chinese standard or Australian standard pin assembly 80.

The American standard pin assembly 40 is suitable for American standard plugs and sockets. The British standard pin assembly 50 is a British standard plug socket. The combined plug-in panel 60 can be assembled between the main body upper cover 20 and the main body lower cover 30 correspondingly, so that the power converter with the pin-specified structure can be replaced between different jacks and pins, the application range of the power converter is expanded, different power supplies in different countries are adapted, and the practicability of the power converter is improved. The Chinese standard or Australian standard pin assembly 80 is a suitable Chinese plug socket or an Australian plug socket. Through the mutual cooperation and conversion between the pin components, users can replace different pins correspondingly, without worrying about the trouble caused by the mismatch between the plug of the electronic equipment they carry and the local power socket. In addition, the American standard pin assembly 40, the British standard pin assembly 50, the CEE7/7 hybrid plug assembly 70, the combined plug-in panel 60, and the Chinese standard pin assembly 80 can realize sliding conversion among different pins through external force, spring compression, and bump displacement, and any pin is completely blocked after being pushed out, thus preventing the risk of electric shock.

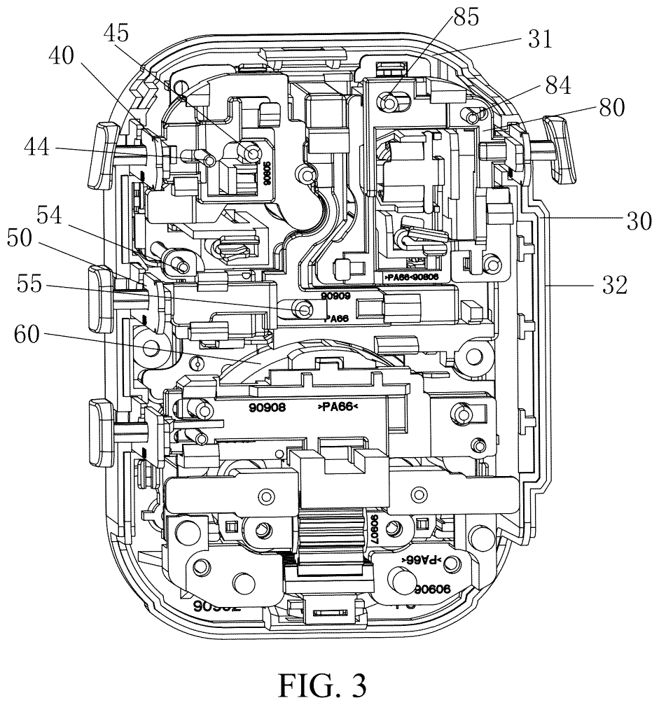

As for the specific structural arrangement of the American standard pin assembly 40, as shown in FIGS. 3, 4, 7 and 8, the American standard pin assembly 40 includes a first connector 41, a first key piece 42 slidably connected to the first connector 41, a first positioning post 44 vertically arranged inside the main body lower cover 30 and sequentially penetrating the first connector 41, and a first positioning post vertically arranged perpendicular to the main body lower cover 30 and penetrating the first connector 41. A first onvex bar 451 is formed on the first guide post 45 along the length direction of the first guide post 45, and a first notch 452 is formed at one end of the first onvex bar 451 corresponding to the bottom plate 31.

As for the specific structural arrangement of the first connector 41, as shown in FIGS. 3, 4, 7 and 8, the first connector 41 includes a first connector main body 411 and a first pin 412 vertically connected to the first connector main body 411 and matched with the combined jack group 33. On the upper end surface of the first connector main body 411, there are formed a first buckle 4111 respectively corresponding to the two sides of the first key piece 42 near one end of the side plate 32, a second buckle 4112 connected to one end of the first key piece 42 far from the side plate 32, a first plug-in positioning hole 4113 for the first positioning post 44 to pass through, a first convex hole 4114 for the first guide post 45 to pass through and move, and a first accommodating groove 4115 is provided for the first spring 43 to move.

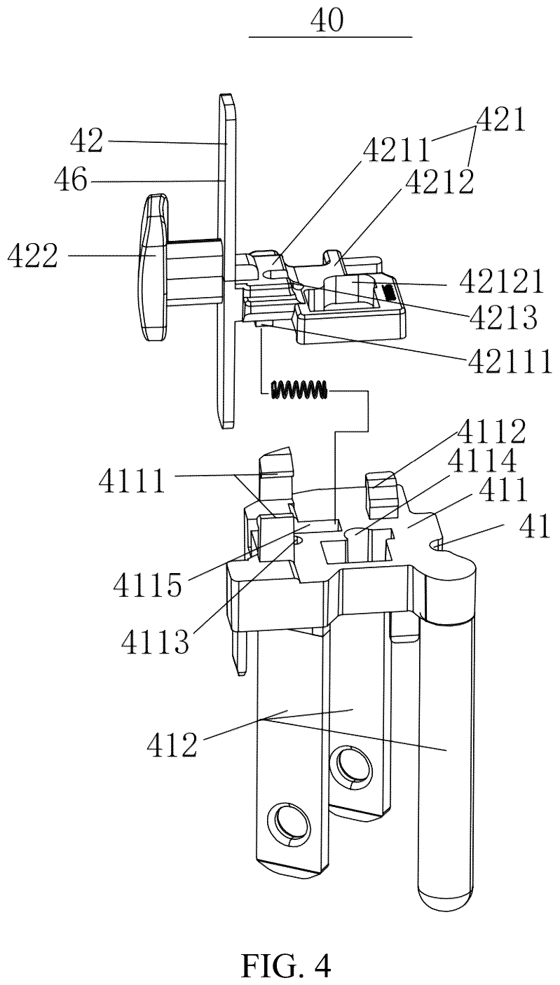

As for the specific structural arrangement of the first pins 412, as shown in FIG. 4, there are four groups of the first pins 412, which correspondingly form American standard pins, so that the pin fixing structure 10 can be used in the United States and other related regions, and improve the application scope and practicability of the power converter.

As for the specific structural arrangement of the first key piece 42, as shown in FIGS. 3, 4 and 12, the first key piece 42 includes a first key main body 421 and a first key 422 connected to one end of the first key main body 421 and sliding between the upper cover 20 and the lower cover 30. The first key main body 421 includes a first key engaging portion 4211 connected with one end of the first key 422 and a first movable engaging portion 4212 connected with the other end of the first key engaging portion 4211, and a first pressing block 42111 movable in the first accommodating groove 4115 is formed on the lower end surface of the first key engaging portion 4211. The first movable engaging portion 4212 is provided with a first key movable groove 42121 opposite to the first convex hole 4114, the first plug-in positioning hole 4113 is sleeved on the first positioning post 44, and the first convex hole 4114 and the first key movable groove 42121 are overlapped and sleeved on the first guide post 45. The first spring 43 is accommodated in the first accommodating groove 4115, and one end of the first spring 43 abuts against the innermost side of the first accommodating groove 4115 and the other end of the first spring 43 abuts against the first pressing block 42111. The first buckle 4111 fastens the first key engaging portion 4211, and the second buckle 4112 fastens the first movable engaging portion 4212, so that the first connector 41 and the first key piece 42 are stably connected.

In order to prevent the first key 422 from causing safety problems when it is used, as shown in FIGS. 3, 4 and 9 to 15, a first fixed electric shock prevention baffle 46 is arranged on the inner side of the first key 422, and a first movable electric shock prevention baffle 47 is also arranged between the first fixed electric shock prevention baffle 46 and the first key 422. A first sliding groove 901 for the first key 422 to slide is formed on the side walls of the main body upper cover 20 and the main body lower cover 30. A first movable baffle groove 902 for the first movable electric shock prevention baffle 47 to slide is respectively formed on the inward sides of the first sliding groove 901, and a first fixed baffle groove 903 for the first fixed electric shock prevention baffle 46 to slide is opened inside the first movable baffle groove 902. The first fixed electric shock prevention baffle 46 slides up and down with the first key 422 in the first movable baffle groove 902, and the first movable electric shock prevention baffle 47 slides up and down in the first fixed baffle groove 903 driven by the first key 422. The stroke of the first key 422 is limited by the first fixed electric shock prevention baffle 46, thereby preventing the first pin 412 from being excessively extended.

As for the specific way that the first movable electric shock prevention baffle 47 is installed on the first key 422, as shown in FIGS. 3, 4 and 9 to 15, a first key movable groove 471 for the first key 422 to move is opened in the middle of the first movable electric shock prevention baffle 47, and a first installation recess groove 472 for the first key 422 to pass through is opened on one side of the first key movable groove 471. The first movable electric shock prevention baffle 47 allows the first key 422 to move in the first key movable groove 471 by allowing the first key 422 to pass through the first installation recess groove 472.

The working principle of the American standard pin assembly 40 is as follows:

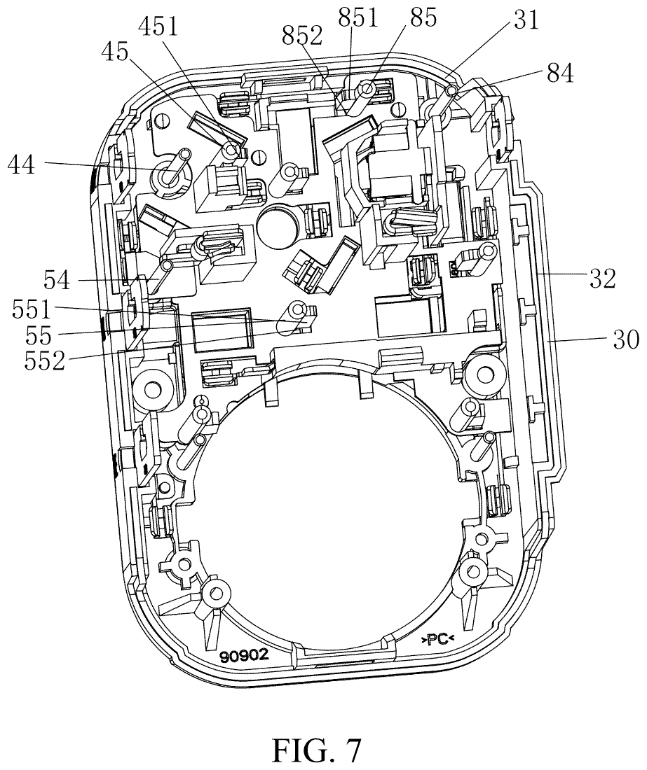

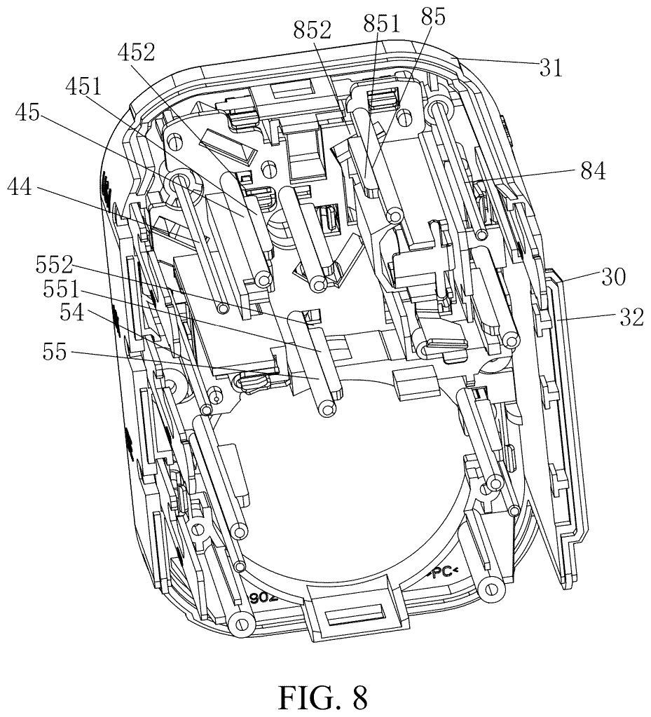

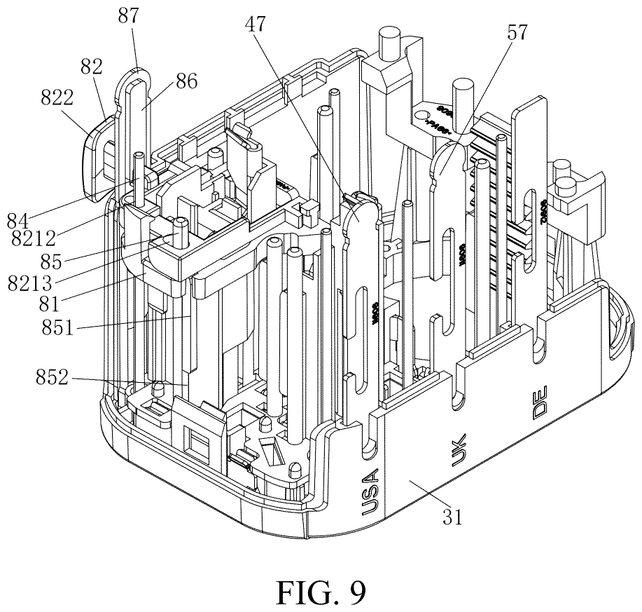

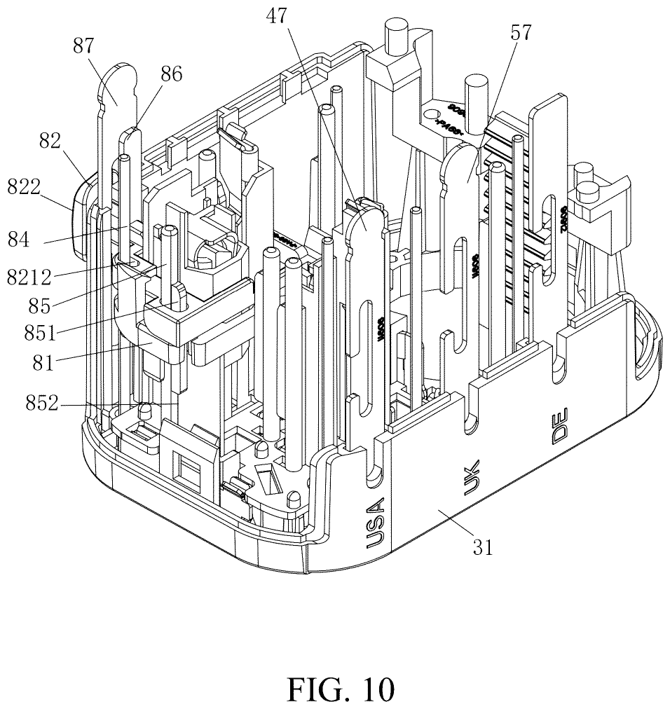

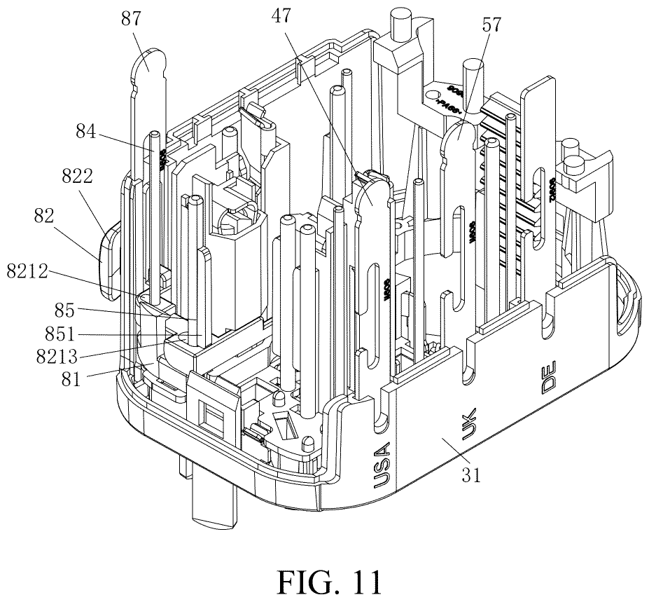

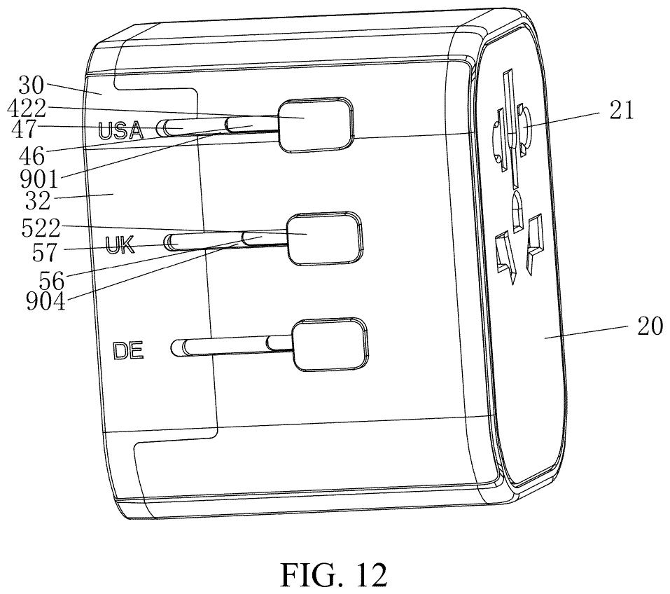

As shown in FIG. 3, FIG. 4, FIG. 7 and FIG. 8, and FIG. 12 to FIG. 15, when no external force is applied to the first key 422, the first key main body 421 is supported by the first convex bar 451, so that the American standard pin assembly 40 cannot move toward the bottom plate 31, so that the American standard pin assembly 40 is positioned at the initial position (refer to FIG. 9), and the first pin 412 is located at the combined jack group 33. When an external force is applied to the first key 422 on the first key piece 42, the first key 422 moves in the first sliding groove 901 towards the main body lower cover 30 and drives the first fixed electric shock prevention baffle 46 to move in the first fixed baffle groove 903 towards the main body lower cover 30. The first movable electric shock prevention baffle 47 first moves in the direction of the main body lower cover 30 with the first key 422 until it abuts against the bottom of the first movable baffle groove 902, and the first key 422 continues to move in the first key movable groove 471 of the first movable electric shock prevention baffle 47, so that the first movable electric shock prevention baffle 47 blocks the gap between the first key 422 and the first sliding groove 901, and prevents children from using the power converter. Wherein, due to the positioning effect among the first convex hole 4114, the first key movable groove 42121, the first plug-in positioning hole 4113 and the first key positioning hole 4213 on the first key main body 421, the first key piece 42 moves towards the end of the first connector 41 near the guide post. At this time, The position deviation of the first convex hole 4114 in the first key main body 421 makes room for the first convex bar 451 to move to the other end of the first connector main body 411 (refer to FIG. 10), so that the first convex bar 451 no longer abuts against the main body 421 of the first key 422, and the American standard pin assembly 40 can move along the first guide post 45 towards the bottom plate 31. When the first key main body 421 moves to the position of the first notch 452 of the first guide post 45, the external force is withdrawn, and the first key main body 421 moves towards one end of the side plate 32, and the first key main body 421 is clamped into the first notch 452, so that the American standard pin assembly 40 is positioned at the termination position (refer to FIG. 11). At this time, the first pin 412 passes through the combined jack group 33 and extends out of the lower cover 30 of the main body. The American standard pin assembly 40 can slide along the first guide post 45 on the lower cover 30 of the main body, and the first convex hole 4114 is matched with the first guide post 45 with the first convex bar 451. Through the first convex hole 4114, the guide post with the first convex bar 451 and the first notch 452, the starting position and the ending position of the American standard pin assembly 40 can be positioned, which is simple, convenient, stable and avoids misoperation. The positioning accuracy of the American standard pin assembly 40 is high.

As for the specific structural arrangement of the British standard pin assembly 50, as shown in FIGS. 3, 5, 7 and 8, the British standard pin assembly 50 includes a second connector 51, a second key piece 52 connected to the second connector 51, a second positioning post 54 vertically arranged inside the main body lower cover 30 and sequentially penetrating the second connector 51, and a second connector 53 perpendicular to the main body lower cover 30 and penetrating the second connector 51. A second convex bar 551 is formed on the second guide post 55 along the length direction of the second guide post 55, and a second notch 552 is formed at one end of the second convex bar 551 corresponding to the bottom plate 31.

As for the specific structural arrangement of the second connector 51, as shown in FIGS. 3, 5, 7 and 8, the second connector 51 comprises a second connector main body 511 and a second pin 512 vertically connected to the second connector main body 511 and matched with the combined jack group 33. On the upper end surface of the second connector main body 511, there are formed a third buckle 5111 for engaging the two sides of the second key piece 52 near the side plate 32, a fourth buckle 5112 for engaging the end of the second key piece 52 far from the side plate 32, a second plug-in positioning hole 5113 for the second positioning post 54 to pass through, a second convex hole 5114 for the second guide post 55 to pass through and move, and the second convex hole 5114 for the second key piece 52 to pass through.

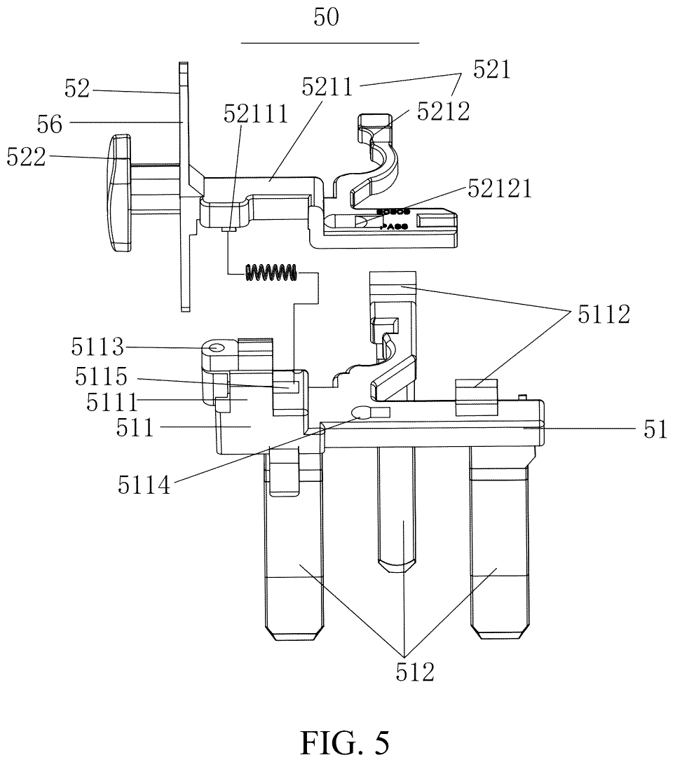

As for the specific structural arrangement of the second pins 512, as shown in FIG. 5, the second pins 512 are divided into three groups, which correspondingly form British pins, so that the pin fixing structure 10 can be used in Britain and other related regions, and the application scope and practicability of the power converter are improved.

As for the specific structural arrangement of the second key piece 52, as shown in FIGS. 3, 5 and 12, the second key piece 52 includes a second key body 521 and a second key 522 connected to one end of the second key body 521 and sliding between the upper cover 20 and the lower cover 30. The second key body 521 includes a second key engaging portion 5211 connected with one end of the second key 522 and a second movable engaging portion 5212 connected with the other end of the second key engaging portion 5211, and a second pressing block 52111 movable in the second accommodating groove 5115 is formed on the lower end surface of the second key engaging portion 5211. A second key positioning hole 5213 facing the second plug-in positioning hole 5113 is formed in the middle of the joint between the second key engaging portion 5211 and the second movable engaging portion 5212, and a second key 522 movable groove 52121 facing the second convex hole 5114 is formed in the second movable engaging portion 5212, and the second plug-in positioning hole 5113 is sleeved on the second positioning post 54. The second spring 53 is accommodated in the second accommodating groove 5115, and one end of the second spring 53 abuts against the innermost side of the second accommodating groove 5115 and the other end of the second spring 53 abuts against the second abutting block 52111. The third buckle 5111 fastens the second key engaging portion 5211, and the fourth buckle 5112 fastens the second movable engaging portion 5212.

In order to prevent the second key 522 from being accidentally inserted into the power converter when it is used, as shown in FIGS. 3, 5 and 9 to 15, a second fixed electric shock prevention baffle 56 is arranged on the inner side of the second key 522, and a second movable electric shock prevention baffle 57 is also arranged between the second fixed electric shock prevention baffle 56 and the second key 522. A second sliding groove 904 for the second key 522 to slide is formed on the side walls of the main body upper cover 20 and the main body lower cover 30, and a second movable baffle groove 905 for the second movable electric shock prevention baffle 57 to slide is respectively formed on the inward sides of the second sliding groove 904, and a second fixed baffle groove 906 for the second fixed electric shock prevention baffle 56 to slide is opened inside the second movable baffle groove 905. The second fixed electric shock prevention baffle 56 slides up and down with the second key 522 in the second movable baffle groove 905, and the second movable electric shock prevention baffle 57 slides up and down in the second fixed baffle groove 906 driven by the second key 522. The stroke of the second key 522 is limited by the second fixed electric shock prevention baffle 56, thereby preventing the second pin 512 from being excessively extended.

For the specific way that the second movable electric shock prevention baffle 57 is installed on the second key 522, as shown in FIGS. 3, 5 and 9 to 15, a second key movable groove 571 for the second key 522 to move is opened in the middle of the second movable electric shock prevention baffle 57, and a second installation recess groove 572 for the second key 522 to pass through is opened on one side of the second key movable groove 571. The second movable electric shock prevention baffle 57 allows the second key 522 to move in the second key movable groove 571 by allowing the second key 522 to pass through the second installation recess groove 572.

The working principle of British standard pin assembly is as follows:

As shown in FIG. 3, FIG. 5, FIG. 7 and FIG. 8, and FIG. 12 to FIG. 15, when no external force is applied to the second key 522, the second key body 521 is supported by the second convex bar 551, so that the British standard pin assembly 50 cannot move toward the bottom plate 31 (refer to FIG. 9), so that the British standard pin assembly 50 is positioned at the initial position, and the second pin 512 is located at the combined jack group 33. When an external force is applied to the second key 522 on the second key piece 52, the second key 522 moves in the second sliding groove 904 towards the main body lower cover 30 and drives the second fixed electric shock prevention baffle 56 to move in the second fixed baffle groove 906 towards the main body lower cover 30. The second movable electric shock prevention baffle 57 first moves in the direction of the main body lower cover 30 with the second key 522 until it abuts against the bottom of the second movable baffle groove 905, and the second key 522 continues to move in the second key movable groove 571 of the second movable electric shock prevention baffle 57, so that the second movable electric shock prevention baffle 57 blocks the gap between the second key 522 and the second sliding groove 904, and prevents children from using the power converter. Due to the positioning effect between the second convex hole 5114, the movable groove 52121 of the second key body 521, the second plug-in positioning hole 5113 and the second key positioning hole 5213, the second key piece 52 moves towards the end of the second connector 51 near the guide post (refer to FIG. 10). At this time, The position deviation of the second convex hole 5114 in the second key body 521 makes room for the second convex bar 551 to move to the other end of the second connector main body 511, so that the second convex bar 551 no longer abuts against the second key body 521, and the British pin assembly 50 can move along the second guide post 55 towards the bottom plate 31. When the second key body 521 moves to the position of the second notch 552 of the second guide post 55, the external force is withdrawn, and the second key body 521 moves towards one end of the side plate 32, and the second key body 521 is clamped into the second notch 552 (refer to FIG. 11), so that the British standard pin assembly 50 is positioned at the termination position, and the British standard pin assembly 50 cannot retreat by itself. At this time, the second pin 512 passes through the combined jack group 33 and extends beyond the lower cover 30 of the main body. The British standard pin assembly 50 can slide along the second guide post 55 on the lower cover 30 of the main body, and the second convex hole 5114 is matched with the second guide post 55 with the second convex bar 551. Through the second convex hole 5114, the guide post with the second convex bar 551 and the second notch 552, the positioning of the starting position and the ending position of the British standard pin assembly 50 is realized, which is simple, convenient, stable and avoids misoperation. The positioning accuracy of the British standard pin assembly 50 is high.

As for the specific structural arrangement of the Chinese standard or Australian standard pin assembly 80, as shown in FIGS. 3, 6, 7 and 8, the Chinese standard pin assembly 80 includes a fourth connector 81, a fourth key piece 82 connected to the fourth connector 81, a fourth positioning post 84 vertically arranged on the inside of the main body lower cover 30 and passing through the fourth connector 81 and the fourth key piece 82 in turn, and the main body lower cover. A fourth convex bar 851 is formed on the fourth guide post 85 along the length direction of the fourth guide post 85, and a fourth notch 852 is formed at one end of the fourth convex bar 851 corresponding to the bottom plate 31.

As for the specific structural arrangement of the fourth connector 81, as shown in FIGS. 3, 6, 7 and 8, the fourth connector 81 includes a fourth connector main body 811 and a fourth pin 812 vertically connected to the fourth connector main body 811 and matched with the combined jack group 33. At least one sixth buckle 8111 clamped on the side of the fourth key piece 82, a fourth plug-in positioning hole 8112 for the fourth positioning post 84 to pass through, at least one fourth convex hole 8113 for the fourth guide post 85 to pass through and move, and a fourth accommodating groove 8114 for the fourth spring 83 to move are formed on the upper end surface of the fourth connection main body 811.

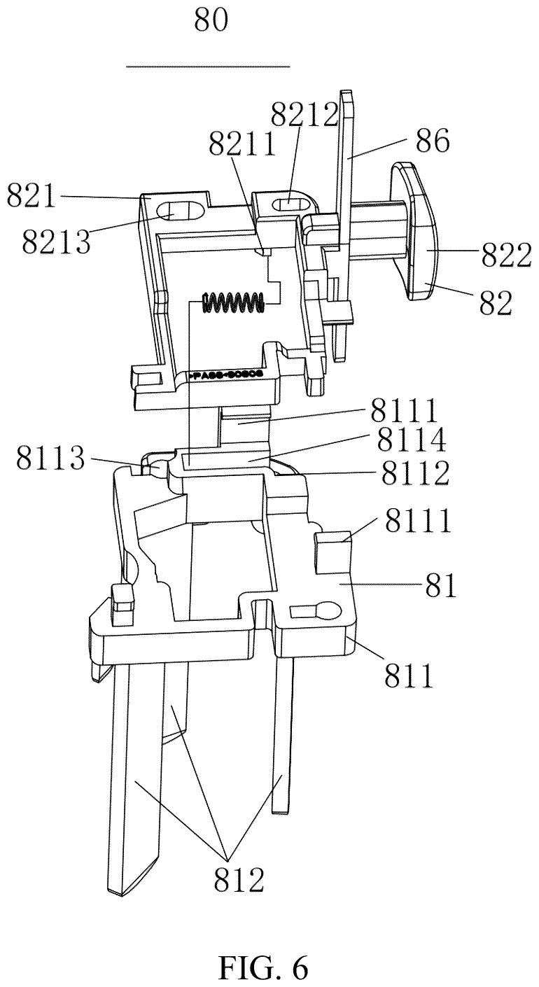

As for the specific structural arrangement of the fourth pins 812, as shown in FIG. 6, the fourth pins 812 are divided into three groups, which correspondingly form standard pins, so that the pin fixing structure 10 can be used in China and other related areas, and the application scope and practicability of the power converter are improved.

As for the specific structural arrangement of the fourth key piece 82, as shown in FIGS. 3, 6, 7 and 8, and 14 to 16, the fourth key piece 82 includes a fourth key body 821 and a fourth key 822 connected to one end of the fourth key body 821 and sliding between the upper cover 20 and the lower cover 30. A fourth pressing block 8211 movable in the fourth accommodating groove 8114 is formed on the lower end face of the fourth key body 821 near the fourth key 822, and a fourth key movable groove 8213 opposite to the fourth plug-in positioning hole 8112 is formed on the fourth key 822. The fourth plug-in positioning hole 8112 and the fourth key positioning hole 8212 are overlapped and sleeved on the fourth positioning post 84, and the fourth convex hole 8113 and the movable groove 8213 of the fourth key 822 are overlapped and sleeved on the fourth guide post 85. The fourth spring 83 is accommodated in the fourth accommodating groove 8114, and one end of the fourth spring 83 abuts against the innermost side of the fourth accommodating groove 8114 and the other end of the fourth spring 83 abuts against the fourth abutting block 8211. The sixth buckle 8111 fastens the main body 821 of the fourth key 822.

In order to prevent the fourth key 822 from being accidentally inserted into the power converter when in use, as shown in FIGS. 3, 6 and 9 to 15, a fourth fixed electric shock prevention baffle 86 is arranged on the inner side of the fourth key 822, and a fourth movable electric shock prevention baffle 87 is also arranged between the fourth fixed electric shock prevention baffle 86 and the fourth key 822. A fourth sliding groove 910 for the fourth key 822 to slide is formed on the side walls of the upper cover 20 and the lower cover 30 of the main body, and a fourth movable baffle groove 911 for the fourth movable electric shock prevention baffle 87 to slide is formed on both inward sides of the fourth sliding groove 910, and a fourth fixed baffle groove for the fourth fixed electric shock prevention baffle 86 to slide is formed on the inner side of the fourth movable baffle groove 911. 912 The fourth fixed electric shock prevention baffle 86 slides up and down along with the fourth key 822 in the fourth movable baffle groove 911, and the fourth movable electric shock prevention baffle 87 slides up and down in the fourth fixed baffle groove driven by the fourth key 822. The stroke of the fourth key 822 is limited by the fourth fixed electric shock prevention baffle 86, thereby preventing the fourth pin 812 from being excessively extended.

As for the specific way that the fourth movable electric shock prevention baffle 87 is installed on the fourth key 822, as shown in FIGS. 3, 6 and 9 to 15, a fourth key movable groove 871 for the fourth key 822 to move is opened in the middle of the fourth movable electric shock prevention baffle 87, and a fourth installation yielding groove 872 for the fourth key 822 to pass through is opened on one side of the fourth key movable groove 871. The fourth movable electric shock prevention baffle 87 allows the fourth key 822 to move in the fourth key movable groove 871 by allowing the fourth key 822 to pass through the fourth installation yielding groove 872.

The working principle of Chinese standard or Australian standard pin assembly is as follows:

As shown in FIG. 3, FIG. 6, FIG. 7, FIG. 8 and FIG. 13 to FIG. 15, when no external force is applied to the fourth key 822, the fourth key body 821 is supported by the fourth convex bar 851, so that the Chinese standard pin assembly 80 cannot move toward the bottom plate 31, so that the Chinese standard pin assembly 80 is positioned at the initial position, and the fourth pin 812 is located above the combined jack group 33. As shown in FIG. 10, when an external force is applied to the fourth key 822 on the fourth key piece 82, the fourth key 822 moves in the fourth sliding groove 910 toward the main body lower cover 30 and drives the fourth fixed electric shock prevention baffle 86 to move in the fourth fixed baffle groove toward the main body lower cover 30. The fourth movable electric shock prevention baffle 87 first moves towards the main body lower cover 30 with the fourth key 822 until it abuts against the bottom of the fourth movable baffle groove 911, and the fourth key 822 continues to move in the fourth key movable groove 871 of the fourth movable electric shock prevention baffle 87, so that the fourth movable electric shock prevention baffle 87 blocks the gap between the fourth key 822 and the fourth sliding groove 910, and prevents children from using the power converter. Due to the positioning of the fourth convex hole 8113, the fourth key movable groove 8213, the fourth plug-in positioning hole 8112 and the fourth key positioning hole 8212 on the fourth key body 821, the fourth key piece 82 moves towards the fourth connector 81 to the middle end of the lower cover 30 of the main body. At this time, The position deviation of the fourth convex hole 8113 in the fourth key body 821 makes room for the fourth convex bar 851 to move to the other end of the fourth insertion main body 811, so that the fourth convex bar 851 no longer abuts against the fourth key body 821, and the Chinese standard pin assembly 80 can move along the fourth guide post 85 towards the bottom plate 31. As shown in FIG. 11, when the fourth key body 821 moves to the position of the fourth groove 852 of the fourth guide post 85, the external force is withdrawn, and the fourth key body 821 moves towards one end of the side plate 32, and the fourth key body 821 is clamped into the fourth groove 852, so that the Chinese standard pin assembly 80 is positioned at the end position. At this time, the fourth pin 812 passes through the combined jack group 33 and extends out of the body lower cover 30. The Chinese standard pin assembly 880 The Chinese standard pin assembly 80 can slide along the fourth guide post 85 on the lower cover 30 of the main body, and the fourth convex hole 8113 is matched with the fourth guide post 85 with the fourth convex bar 851. Through the fourth convex hole 8113, the guide post with the fourth convex bar 851 and the fourth groove 852, the starting position and the ending position of the Chinese standard pin assembly 80 can be positioned, which is simple, convenient, stable and avoids misoperation. The positioning accuracy of the Chinese standard pin assembly 80 is high.

The combined jack group 33 and the socket hole 21 correspond to the first pin 412, the second pin 512, the third pin 712 and the fourth pin 812 respectively.

The technical features of the above embodiments can be combined at will. In order to make the description concise, not all possible combinations of the technical features in the above embodiments are described. However, as long as there is no contradiction between the combinations of these technical features, they should be considered as the scope recorded in this specification.

What needs to be explained here is that the electric shock prevention baffle structure of the pin assembly disclosed in this utility model is an improvement on the specific structure, but it is not an innovation of this utility model for the specific control mode. The pins and other parts involved in the utility model can be general standard parts or parts known to those skilled in the art, and their structures, principles and control methods are known to those skilled in the art through technical manuals or conventional experimental methods.

1. An electric shock prevention baffle structure of a pin assembly, comprising a main body upper cover and a main body lower cover installed on the main body upper cover, wherein the main body upper cover is provided with socket holes, and the main body lower cover comprises a bottom plate and a side plate vertically connected to the bottom plate, and the bottom plate is provided with a combined jack group, characterized in that further comprises at least one pin assembly arranged on the main body lower cover, and each pin assembly comprises at least one live pin and at least one zero pin and a key; a fixed electric shock prevention baffle is formed inside the key, and a movable electric shock prevention baffle is arranged between the fixed electric shock prevention baffle and the key; sliding grooves for the keys to slide are formed on the side walls of the main body upper cover and the main body lower cover; the inner side of the sliding grooves are respectively formed with a movable baffle groove for the movable electric shock prevention baffle to embed and slide; A key movable groove is opened in the middle of the movable electric shock prevention baffle for the key to move, and one side of the button movable groove is provided with an installation yielding groove for the key to pass through the installation.

2. The electric shock prevention baffle structure of the pin assembly according to claim 1, characterized in that the key movable groove is a rectangular or arc-shaped runway shape as a whole.

3. The electric shock prevention baffle structure of the pin assembly according to claim 1, characterized in that the pin assembly includes American standard pin assembly, British standard pin assembly, and Chinese or Australian standard pin assembly.

4. The electric shock prevention baffle structure of the pin assembly according to claim 3, characterized in that the American standard pin assembly comprises a first connector, a first key piece connected to the first connector, a first positioning post vertically arranged inside the lower cover of the main body and sequentially penetrating the first connector, and a first guide post perpendicular to the main body lower cover and penetrating the first connector; a first convex bar is formed on the first guide post along the length direction of the first guide post, and one end of the first convex bar corresponding to the bottom plate is provided with a first notch.

5. The electric shock prevention baffle structure of the pin assembly according to claim 4, characterized in that the first connector comprises a first connection main body and a first pin vertically connected to the first connection main body and matched with the combined jack group, and the upper end surface of the first connection main body is formed with a first buckle respectively engaged with two sides of one end of the first key piece near the side plate, a second buckle engaged with one end of the first key piece far from the side plate, a first plug-in positioning hole for the first positioning post to pass through, and a first plug-in positioning hole for the first positioning post to pass through. The first key piece comprises a first key main body and a first key connected to one end of the first key main body and sliding between the upper cover and the main body lower cover; the first key main body comprises a first key engaging portion connected to one end of the first key and a first movable engaging portion connected to the other end of the first key engaging portion; a first pressing block movable in the first accommodating groove is formed on the lower end face of the first key engaging portion; a first key positioning hole is formed in the middle of the joint between the first key engaging portion and the first movable engaging portion, and the first movable engaging portion is provided with a first key movable groove facing the first convex hole, and the first key positioning hole and the first key positioning hole are overlapped and sleeved on the first positioning post, and the first convex hole and the first key movable groove are overlapped and sleeved on the first guide post; The first spring is accommodated in the first accommodating groove with one end abutting against the innermost side of the first accommodating groove and the other end abutting against the first abutting block; a first fixed electric shock prevention baffle is arranged on the inner side of the first key, and a first movable electric shock prevention baffle is also arranged between the first fixed electric shock prevention baffle and the first key; the side walls of the main body upper cover and the main body lower cover are provided with a first sliding groove for the first key to slide, and the inward two sides of the first sliding groove are respectively provided with a first movable baffle groove for the first movable electric shock prevention baffle to embed and slide, and the inner side of the first movable baffle groove is provided with a first fixed baffle groove for the first fixed electric shock prevention baffle to slide; the middle part of the first movable electric shock prevention baffle is provided with a first key movable groove for the first key to move, and one side of the first key movable groove is provided with a first installation yielding groove for the first key to pass through and install.

6. The electric shock prevention baffle structure of the pin assembly according to claim 1, characterized in that the British standard pin assembly comprises a second connector, a second key connected to the second connector in a sliding way, a second positioning post vertically arranged on the inside of the lower cover of the main body and sequentially penetrating the second connector, and a second guide post perpendicular to the lower cover of the main body and penetrating the second connector; a second convex bar is formed on the second guide post along the length direction of the second guide post, and a second notch is formed at one end of the second convex bar corresponding to the bottom plate.

7. The electric shock prevention baffle structure of the pin assembly according to claim 6, characterized in that the second connector comprises a second connection main body and a second pin vertically connected to the second connection main body and matched with the combined jack group, and the upper end surface of the second connection main body is formed with a fourth buckle respectively engaged with two sides of one end of the second key piece near the side plate, a fourth buckle engaged with one end of the second key piece far from the side plate, a second connection positioning hole for the second positioning post to pass through, and a second plug-in positioning hole for the second positioning post to pass through. The second key piece comprises a second key body and a second key connected to one end of the second key body and sliding between the upper cover and the lower cover of the main body, wherein the second key body comprises a second key engaging portion connected to one end of the second key and a second movable engaging portion connected to the other end of the second key engaging portion, and a second pressing block movable in the second accommodating groove is formed on the lower end surface of the second key engaging portion; the second movable engaging portion is provided with a second key movable groove opposite to the second convex hole, the second plug-in positioning hole is sleeved on the second positioning post, and the second convex hole and the second key movable groove are overlapped and sleeved on the second guide post; the second spring is accommodated in that second accommodate groove, one end of the second spring abuts against the innermost side of the second accommodating groove, and the other end of the second spring abuts against the second abutting block; a second fixed electric shock prevention baffle is arranged on the inner side of the second key, and a second movable electric shock prevention baffle is also arranged between the second fixed electric shock prevention baffle and the second key; the side walls of the main body upper cover and the main body lower cover are formed with a second sliding groove for the second key to slide, and the inward two sides of the second sliding groove are respectively formed with a second movable baffle groove for the second movable electric shock prevention baffle to embed and slide, and the inner side of the second movable baffle groove is provided with a second fixed baffle groove for the second fixed electric shock prevention baffle to slide; the middle part of the second movable electric shock prevention baffle is provided with a second key movable groove for the second key to move, and one side of the second key movable groove is provided with a second installation yielding groove for the second key to pass through and install.

8. The electric shock prevention baffle structure of the pin assembly according to claim 1, characterized in that the Chinese standard or Australian standard pin assembly comprises a fourth connector, a fourth key piece connected to the fourth connector, a fourth positioning post vertically arranged inside the lower cover of the main body and passing through the fourth connector in turn, and at least one fourth guide post perpendicular to the lower cover of the main body and passing through the fourth connector; A fourth convex bar is formed on the fourth guide post along the length direction of the fourth guide post, and a fourth notch is formed at one end of the fourth convex bar corresponding to the bottom plate.

9. The electric shock prevention baffle structure of the pin assembly according to claim 8, characterized in that the fourth connector comprises a fourth connector main body and a fourth pin vertically connected to the fourth connector main body and matched with the combined jack group, and the upper end surface of the fourth connector main body is formed with at least one sixth buckle clamped on the side of the fourth key piece, a fourth connector positioning hole for the fourth positioning post to pass through, at least one fourth convex hole for the fourth guide post to pass through and move, and the fourth convex hole for the fourth guide post to pass through; the fourth key piece comprises a fourth key body and a fourth key connected to one end of the fourth key body and sliding between the upper cover and the lower cover of the main body, and a fourth pressing block moving in the fourth accommodating groove is formed on the lower end face of one end of the fourth key body close to the fourth key; the fourth key is provided with a fourth key positioning hole facing the fourth plug-in positioning hole and a fourth key movable groove facing the fourth convex hole, and the fourth plug-in positioning hole and the fourth key positioning hole are overlapped and sleeved on the fourth positioning post, and the fourth convex hole and the fourth key movable groove are overlapped and sleeved on the fourth guide post; the fourth spring is accommodated in the fourth accommodating groove, one end of which abuts against the innermost side of the fourth accommodating groove and the other end of which abuts against the fourth abutting block; A fourth fixed electric shock prevention baffle is arranged on the inner side of the fourth key, and a fourth movable electric shock prevention baffle is also arranged between the fourth fixed electric shock prevention baffle and the fourth key; a fourth sliding groove for the fourth key to slide is formed on the side walls of the upper cover and the lower cover of the main body, and a fourth movable baffle groove for the fourth movable electric shock prevention baffle to embed and slide is respectively formed on the inward two sides of the fourth sliding groove, and a fourth fixed baffle groove for the fourth fixed electric shock prevention baffle to slide is opened at the inner side of the fourth movable baffle groove; the middle part of the fourth movable electric shock prevention baffle is provided with a fourth key movable groove for the fourth key to move, and one side of the fourth key movable groove is provided with a fourth installation yielding groove for the fourth key to pass through and install.
